(19) United States
(12) Patent Application Publication
(10) Pub. No.: US 2023/0244014 A1
(43) Pub. Date: Aug. 3, 2023

(54) OPTICAL ELEMENT AND OPTICAL MODULE

(71) Applicant: Zhejiang Crystal-Optech Co., Ltd., Taizhou, Zhejiang (CN)

(72) Inventors: Zhaokun Wang, Taizhou (CN); Weiming Wu, Taizhou (CN); Fenglei Liu, Taizhou (CN)

(73) Assignee: Zhejiang Crystal-Optech Co., Ltd., Taizhou, Zhejiang (CN)

(21) Appl. No.: 18/026,804

(22) PCT Filed: Dec. 13, 2021
(86) PCT No.: PCT/CN2021/137464

§ 371 Date: Mar. 16, 2023

(30) Foreign Application Priority Data
Mar. 4, 2021 (CN) 202110238053.7

(51) Int. Cl. G02B 5/18

(52) U.S. Cl. CPC G02B 5/188; G02B 1/11

(57) ABSTRACT

An optical element (100) and an optical module (200), relating to the technical field of optics. The optical element comprises a diffractive optical element (110), and a Fresnel lens (120) connected to the diffractive optical element (110), such that a light beam that passes through the Fresnel lens (120) and is then transmitted through the diffractive optical element (110) forms a preset pattern. The assembly cost and the assembly difficulty can be reduced, and miniaturization of the optical module (200) can be facilitated.

### CROSS-REFERENCE TO RELATED APPLICATIONS

The present disclosure claims the priority to a Chinese patent application with the application number 202110238053.7 and entitled “Optical Element and Optical Module” filed with the China National Intellectual Property Administration on Mar. 4, 2021, the entire contents of which are incorporated herein by reference.

### TECHNICAL FIELD

The present disclosure relates to the field of optical technology, in particular, to an optical element and an optical module.

### BACKGROUND ART

Optical modules are applied in modern products more extensively, such as structure light in electronic equipment. Structured light, by projecting a specific pattern to the surface of the object, and collecting it through the receiving module, calculates the position and depth information of the object according to the variation of the light signal caused by the object, and then restores the entire depth space. The pattern can be designed as stripe form, regular dot matrix form, grid form, speckle form, coding form and so on, or even more complex light patterns. With the development of optical technology, the application range of structure light becomes more extensive, such as face recognition, gesture recognition, projectors, three-dimensional (3D) outline reconstruction, depth measurement, anti-counterfeiting identification, etc. Therefore, the optical module has become the focus of people's research.

An optical module in the related technologies mainly includes a light source, a collimation lens and optical elements, wherein the light beam emitted by the light source is modulated into collimated light by the collimation lens, and after entering the optical elements and diffracting a pattern array of multiple light spots, it is projected onto the object. Multiple sets of lenses are generally required to collimate and diffract the light beam, however, they are prone to deviation during the loading process, which affects the reliability of the light beam propagation; and multiple sets of lenses are prone to failure after assembly or reliability testing, which leads to a high assembly defective rate of optical module; and the combination of multiple sets of lenses takes up larger space, consumes assembly man-hours, and increases production costs.

### SUMMARY

The present disclosure provides an optical element and an optical module, which can reduce the assembly cost and the difficulty of assembly, and facilitate the miniaturization of the optical module.

Some embodiments of the present disclosure provide an optical element, the optical element may include a diffractive optical element, and a Fresnel lens which is connected to the diffractive optical element, such that the light beam may pass through the diffractive optical element after passing through the Fresnel lens, so as to form a preset pattern.

Optionally, the diffractive optical element may include a transparent substrate, and a diffractive layer disposed on the transparent substrate.

Optionally, a constituent material of the transparent substrate may be glass or resin, and the diffraction layer may be patterned by micro-nano etching or imprinting process.

Optionally, the diffractive layer may be filled with a filling layer covering the diffractive layer, or a cover plate may be provided on the diffractive layer.

Optionally, the Fresnel lens may be disposed on the transparent substrate, or the Fresnel lens may be disposed on the filling layer.

Optionally, the difference value between the refractive index n₁ of the diffractive optical element and the refractive index n₂ of the filling layer may be: |n₁−n₂|≥0.2.

Optionally, the material forming the diffractive optical element has a higher refractive index than the material forming the filling layer, or the material forming the diffractive optical element has a lower refractive index than the material forming the filling layer.

Optionally, a transparent conductive layer may be provided on one side of the transparent substrate.

Optionally, the transparent conductive layer may be made by transparent metal oxide or metal doped oxide.

Optionally, the Fresnel lens may include a substrate, and a collimating layer disposed on the substrate, so that the light beam passing through the Fresnel lens are emitted in parallel, wherein the collimating layer is located on the side of the substrate away from the transparent substrate.

Optionally, the structure types of the diffractive layer and the collimating layer may respectively adopt any one of stepped type and continuous type.

Optionally, at least one of an anti-reflective film layer, a wear-resistant layer, or a hydrophobic and oleophobic layer may be provided on the light-transmitting surface of the filling layer or the transparent substrate.

Other embodiments of the present disclosure provide an optical module, which may include any one of the optical elements described above and a light source, wherein the light source may be located at the focal plane of the Fresnel lens of the optical element, and the collimating portion of the Fresnel lens faces towards the light source.

Optionally, the light source in the optical module can be a vertical cavity surface emitting laser or a laser diode.

The embodiments of the present disclosure at least include the following beneficial effects.

The optical element and the optical module provided in the embodiments of the present disclosure connect the diffractive optical element with the Fresnel lens, such that the structural optical element may be formed as an integral body with optical properties of collimation and diffraction at the same time. When processing optical elements, the alignment error between the diffractive optical element and the Fresnel lens depends on the alignment capability between the wafers, wherein its alignment accuracy is much higher than that between lens sets, compared to the traditional mode using lens sets to assemble. In addition, by using the optical elements provided by the embodiments of the present disclosure, only single optical element is needed to be assembled during assembly, such that the assembly efficiency is higher. Compared with the method using discrete collimation lens set and DOE elements, the assembly cost and assembly difficulty can be reduced. In addition, the space occupied by a single optical element is smaller, which is conducive to the miniaturization design of the optical module.

### BRIEF DESCRIPTION OF DRAWINGS

In order to illustrate the technical solutions of the embodiments of the present disclosure more clearly, the drawings used in the embodiments will be briefly introduced below. It should be understood that the following drawings only show some embodiments of the present disclosure, but they should not be regarded as a limitation on the scope, and those of ordinary skilled in the art can also obtain other related drawings based on these drawings without creative work.

FIG. 1 is the first structural schematic diagram of the optical element provided by the embodiment of the present disclosure;

FIG. 2 is the second structural schematic diagram of the optical element provided by the embodiment of the present disclosure;

FIG. 3 is the third structural schematic diagram of the optical element provided by the embodiment of the present disclosure;

FIG. 4 is the fourth structural schematic diagram of the optical element provided by the embodiment of the present disclosure;

FIG. 5 is the fifth structural schematic diagram of the optical element provided by the embodiment of the present disclosure;

FIG. 6 is the sixth structural schematic diagram of the optical element provided by the embodiment of the present disclosure;

FIG. 7 is the first structural schematic diagram of the optical module provided by the embodiment of the present disclosure;

FIG. 8 is the second structural schematic diagram of the optical module provided by the embodiment of the present disclosure;

FIG. 9 is the third structural schematic diagram of the optical module provided by the embodiment of the present disclosure;

FIG. 10 is the fourth structural schematic diagram of the optical module provided by the embodiment of the present disclosure; and

FIG. 11 is the fifth structural schematic diagram of the optical module provided by the embodiment of the present disclosure.

Reference numerals: 100-optical element; 110-diffractive optical element; 112-transparent substrate; 114-diffractive layer; 120-Fresnel lens; 122-substrate; 124-collimating layer; 130-filling layer; 140-cover plate; 200-optical module; 210-light source.

### DETAILED DESCRIPTION OF EMBODIMENTS

In order to make the purposes, technical solutions and advantages of the embodiments of the present disclosure more clearly, the technical solutions in the embodiments of the present disclosure will be clearly and completely described below in conjunction with the drawings in the embodiments of the present disclosure. Obviously, the described embodiments are a part of the embodiments of this disclosure, not all of them. Generally, the components of the embodiments of the present disclosure described and illustrated in the drawings herein may be arranged and designed in a variety of different configurations.

Accordingly, the following detailed description of the embodiments of the present disclosure provided in the drawings is not intended to limit the scope of the present disclosure, but merely represents selected embodiments of the present disclosure. Based on the embodiments in the present disclosure, all other embodiments obtained by persons of ordinary skill in the art without creative efforts fall within the protection scope of the present disclosure.

It should be noted that similar numerals and letters denote similar items in the following figures, therefore, once an item is defined in one figure, it does not require further definition and explanation in subsequent figures.

In the description of the present disclosure, it should also be noted that, unless otherwise clearly stipulated and limited, the terms “provide” and “connect” should be understood in a broad sense, for example, it can be a fixed connected or a detachable connected, or integrated connected; it can be directly connected or indirectly connected through an intermediary, and it can be the internal communication between two components. Those of ordinary skill in the art can understand the specific meanings of the above terms in the present disclosure in specific situations.

Optical elements are widely used in many scenarios, for example, the whole system of 3D structure light includes a structure light projection module, a camera, and an image acquisition and processing system. Its process is that the projection module emits light beams onto the measured object, the camera captures the three-dimensional light pattern formed on the measured object, and the captured image is processed by the acquisition and processing system to obtain the surface data of the measured object. In this system, when the relative position of the camera and the projection module is fixed, the distortion degree of the light beams projected on the measured object is determined by the depth of the object surface, so a light beam image with depth can be obtained in the captured image.

The projection module is one of the important components of the entire 3D vision; and it is used to emit specially modulated invisible infrared light to the shot object, and the quality of the emitted image is crucial to the overall recognition effect. When the projection module is in use, it needs to emit invisible infrared light through an invisible-infrared-light emission source, the invisible infrared light is calibrated through a collimation lens and the calibrated invisible infrared light passes through the diffractive optical element (DOE) for diffraction to obtain the desired light spot pattern.

In the traditional projection module, the collimation lens and DOE are discrete elements, such that the whole module has problems such as large space occupied, low alignment accuracy, and high assembly cost, which causes great limitations. In the embodiments of the present disclosure, a single optical element is used to simultaneously implement the functions of collimation and diffraction, so as to solve the above problems.

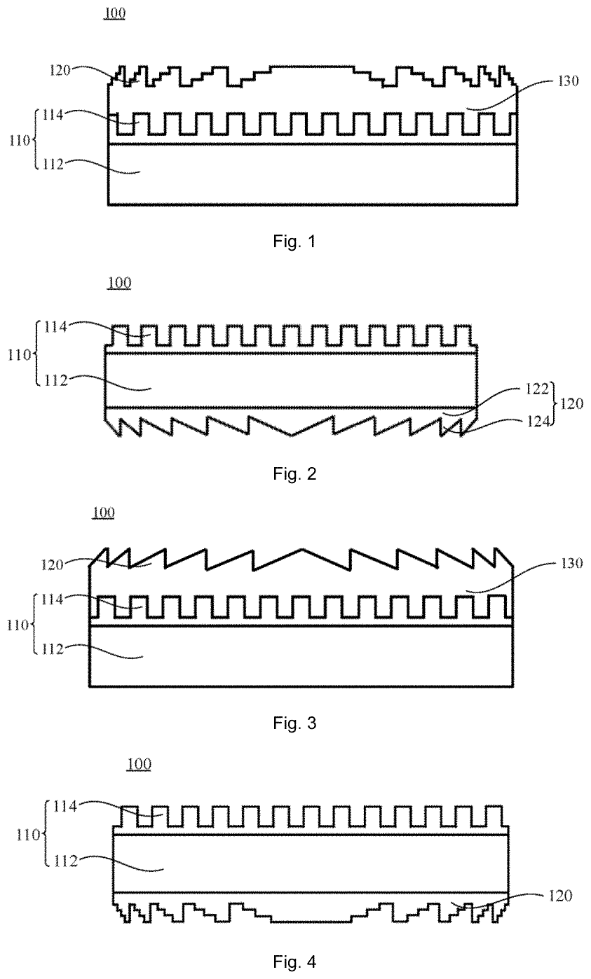

Referring to FIG. 1 and FIG. 2, the embodiment provides an optical element 100, which may include a diffractive optical element 110, and a Fresnel lens 120 connected to the diffractive optical element 110, such that the light beam passes through the Fresnel lens 120 and then passes through the diffractive optical element 110 to form a preset pattern.

Specifically, the diffractive optical element 110 and the Fresnel lens 120 are connected to form an integrated structure, or they are integrally molded in the form of imprinting, etching or laser direct writing on the same substrate, such that the alignment error between the diffractive optical element 110 and the Fresnel lens 120 depends on the alignment capability (in micron-level) between wafers, which is much smaller than the alignment error (in millimeter-level) between elements in the traditional method. By adopting the above method, the overall optical performance of the optical element 100 can be improved.

When using the optical element 100 provided by the embodiment of the present disclosure, the light source is placed at the focal plane of the Fresnel lens 120. A scattered light spot emitted by the light source will be collimated when passing through the Fresnel lens 120 in the optical element 100, and then enter the diffractive optical element 110 in parallel, and the diffractive optical element 110 may diffract the collimated light to form a preset pattern. The preset pattern may be designed into a stripe form, a regular dot matrix form, a grid form, a speckle form, a coding form, etc. according to actual needs, which is not specified in the embodiments of the present disclosure.

By connecting the diffractive optical element 110 with the Fresnel lens 120, the optical element 100 provided in the embodiment of the present disclosure may be formed as an integral body with optical properties of collimation and diffraction at same time. When processing the optical element 100, the alignment error between the diffractive optical element 110 and the Fresnel lens 120 depends on the alignment capability between the wafers, wherein its alignment accuracy is much higher than that between lens sets, compared to the traditional mode using lens sets to assemble. In addition, with the optical element 100 provided in the embodiment of the present disclosure, only single optical element 100 needs to be assembled during assembly, which has a higher assembly efficiency and reduces the assembly cost and assembly difficulty, compared with using discrete collimating lens sets and DOE elements. In addition, with the use of a single optical element 100, less space is occupied, which is beneficial to the miniaturization design of the optical module 200.

As shown in FIG. 1 and FIG. 2, the diffractive optical element 110 may include a transparent substrate 112 and a diffractive layer 114 disposed on the transparent substrate 112.

Specifically, the material of the transparent substrate 112 can be glass or resin, and the diffractive layer 114 can be patterned by adopting micro-nano etching process, such that the laser is diffracted after passing through each diffractive unit to form a specific light intensity distribution, such as generating a dot matrix, or to produce a uniform-light diffuser according to actual needs. The specific pattern of the diffraction unit of the diffractive optical element 110 is determined by the operating wavelength, the dot matrix distribution of the used vertical cavity surface emitting laser (VCSEL), and the finally required diffraction pattern distribution. The height of the diffractive optical element 110 is determined by the operating wavelength, the difference in the refractive index of the used two materials, and the number of steps. In addition, the diffractive layer 114 can be formed by nano-imprinting to obtain the required diffractive units.

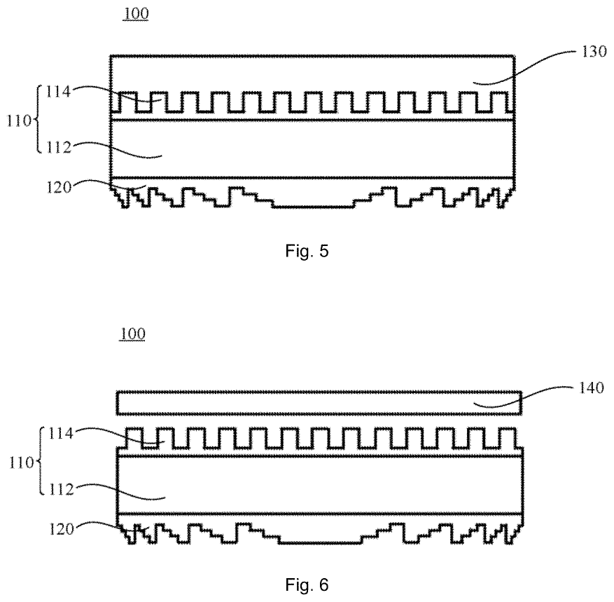

As shown in FIG. 4, FIG. 5 or FIG. 6, a filling layer 130 may be filled to covering the diffractive layer 114, or the diffractive layer 114 may be provided with a cover plate 140.

Specifically, as shown in FIG. 4 and FIG. 5, when the diffractive optical element 110 and the Fresnel lens 120 are respectively located on opposite sides of the transparent substrate 112, after the diffractive layer 114 is formed by the approach, such as etching, imprinting, and laser direct writing, on the transparent substrate 112, the diffractive layer 114 can be filled with a covering filling layer 130, thereby the diffractive layer 114 is wrapped by the filling layer 130 to ensure the stability of the structure of the diffraction layer 114, so as to ensure the stability of the structure of the diffractive layer 114 and avoid affecting the structure of the diffractive layer 114 due to external collision. As shown in FIG. 6, a cover plate 140 may also be provided on the diffractive part of the diffractive optical element 110 to protect the diffractive layer 114 of the diffractive optical element 110, thereby ensuring the stability of the optical element 100 during use.

In order to ensure that the light beam collimated by the Fresnel lens 120 can be diffracted by the diffractive layer 114 to form the desired pattern, it is necessary that the difference value between the refractive index n₁ of the diffractive optical element 110 and the refractive index n₂ of the filling layer 130 may be: |n₁−n₂|≥0.2.

Specifically, the material forming the diffractive optical element 110 may have a relatively higher refractive index, and the material forming the filling layer 130 may have a relatively lower refractive index. The material forming the diffractive optical element 110 also may have a relatively lower refractive index, and the material forming the filling layer 130 has a relatively higher refractive index. It is not specified in the embodiment of the present disclosure. When |n₁−n₂|≥0.2, both the diffraction effect and the preset pattern obtained will be better.

It should be noted that different refractive indices are used to ensure the normal generation of diffraction, if materials with the same refractive index are used, it can be considered that a same structure is formed by the filling layer 130 and the diffractive layer 114 and there is no diffractive layer 114 anymore. Therefore, the refractive indices of the filling layer 130 and the diffractive optical element 110 need to be different. In addition, when there is no filling layer 130, the diffractive optical element 110 and the air also have different refractive indices, which can also ensure the normal generation of the desired pattern.

As shown in FIG. 3 and FIG. 4, the Fresnel lens 120 may be disposed on the transparent substrate 112, or the Fresnel lens 120 may be disposed on the diffractive layer 114.

Specifically, FIG. 3 is a structural schematic diagram of the Fresnel lens 120 disposed on the diffractive layer 114. When the Fresnel lens 120 and the diffractive optical element 110 are located on the same side of the transparent substrate 112 during the preparation of the Fresnel lens 120, the filling layer 130 can be directly formed in the approach of imprinting, etching or laser direct writing, etc. In this way, the filling layer 130 is made of the same material as the Fresnel lens 120, and is conducive to a more stable combination between the Fresnel lens 120 and the filling layer 130. The materials of the Fresnel lens 120 and the filling layer 130 may be ultraviolet curable glue or the like. It can be understood that the material of the filling layer 130 may also be different from that of the Fresnel lens 120. In this case, after the filling layer 130 is filled and coated on the diffractive layer 114 and then flattened, a new layer is then set and the Fresnel lens 120 is formed by imprinting.

FIG. 4 is a structural schematic diagram of the Fresnel lens 120 disposed on transparent substrate 112. After the master mask of diffractive optical element 110 and the master mask of Fresnel lens 120 are produced, the main structure of the diffractive optical element 110 and the Fresnel lens 120 can be directly imprinted on the opposite sides of the transparent substrate 112, respectively, and the required optical element 100 is formed finally by demolding. In order to ensure the effective protection of the diffractive optical element 110 in the formation of the optical element 100, the covering filling layer 130 can be filled on the diffractive layer 114 of the diffractive optical element 110. When the optical element 100 is prepared in the above method, the materials of the diffractive optical element 110 and the Fresnel lens 120 may be the same or different. It should be noted that regardless of the form of preparation, alignment error can be reduced by adding alignment marks.

In an optional embodiment of the present disclosure, one side of the transparent substrate 112 may be provided with a transparent conductive layer.

Specifically, the transparent conductive layer can be made of transparent metal oxide or metal doped oxide, such as indium tin oxide, zinc oxide, tin oxide, indium-doped tin oxide, tin-doped gallium trioxide, tin-doped silver indium oxide, indium tin oxide, zinc-doped indium trioxide, antimony-doped tin dioxide, aluminum-doped zinc oxide, etc. When the method shown in FIG. 1 or FIG. 3 is adopted, the transparent conductive layer may be disposed entirely on the side of the transparent substrate facing away from the diffractive optical element 110. When adopting the method shown in FIG. 2, FIG. 4 or FIG. 5, the transparent conductive layer can be arranged entirely on one side of the transparent substrate 112 first, and then the diffractive optical element 110 and the Fresnel lens 120 are respectively formed on the transparent substrate through double-sided imprinting. In this case, the transparent conductive layer may be on the diffractive optical element 110 or the Fresnel lens 120. By using the above method, when the optical element 100 is broken, the transparent conductive layer will be disconnected to interrupt the detection circuit, such that the controller corresponding to the optical module 200 can determine the state of the optical element 100 according to the on or off of the transparent conductive layer. When the optical element 100 is intact, the light source 210 can emit light normally, and the laser emitted by the light source 210 is diffracted by the optical element 100 and thus will not cause damage to human eyes. When the optical element 100 is broken, the controller will control the light source 210 to turn off, to prevent the light beam emitted by the light source 210 from directly emitting, thereby effectively protecting the user, and the safety of the product can be improved in use.

As shown in FIG. 2, the Fresnel lens 120 may include a substrate 122, and a collimating layer 124 arranged on the substrate 122, so that the light beams passing through the Fresnel lens 120 are emitted in parallel, wherein the collimating layer 124 is positioned on the side of the substrate 122 facing away from the transparent substrate 112.

Specifically, the Fresnel lens 120 can be molded by imprinting, etching or laser direct writing on the transparent substrate 112. When the above-mentioned forms are used, the substrate 122 and the transparent substrate 112 can be regarded as the same feature. In addition, imprinting glue can also be coated on the transparent substrate 112 and the Fresnel lens 120 is imprinted on the surface of the imprinting glue, so that the connection between the Fresnel lens 120 and the transparent substrate 112 can be formed. When adopting imprinting molding, the required master mask can be prepared by etching or laser direct writing, performing the imprinting by the master mask is beneficial to reduce production costs, facilitates mass production and improves production efficiency. In addition, the light beams passing through Fresnel lens 120 are emitted in parallel, which specifically means that the emitted light beams are parallel to each other. Moreover, the emitted light beams and the plane of the transparent substrate 112 are perpendicular to each other, so as to ensure effective collimation of the light beams.

In an optional embodiment of the present disclosure, the structure types of the diffractive layer 114 and the collimating layer 124 may respectively adopt any one of stepped type and continuous type.

Specifically, the diffractive layer 114 of the diffractive optical element 110 may include a diffractive unit. The individuals forming the diffractive unit may adopt a stepped type or a continuous type, wherein the stepped structure of the diffractive layer 114 may be a stepped structure such as two steps, four steps or eight steps and so on. Similarly, the collimating layer 124 of the Fresnel lens 120 may also be in the stepped type (as shown in FIG. 1) or the continuous type (as shown in FIG. 2). The stepped structure of the collimation layer 124 may be a stepped structure such as four steps, eight steps, or more steps as required. In addition, the Fresnel lens 120 used in the embodiment of the present disclosure is preferably a micro-nano level Fresnel lens, and this microstructure is finer and has higher precision compared with the ordinary Fresnel structure. On the premise of reducing the number of lenses of the collimation element, it can ensure good light-gathering and imaging performance, and can also reduce the impact of the spherical aberration of the collimation element on the laser quality to a certain extent. It should be noted that the height of the Fresnel lens 120 in continuous type is about 10-30 um, which is based on the principle of refraction. The height of the Fresnel lens 120 in stepped type is about 1-2 um, which is based on the principle of diffraction, and higher diffraction efficiency is obtained through the phase change of the Fresnel zone plate.

In an optional embodiment of the present disclosure, the light-transmitting surface of the transparent substrate 112 or the filling layer 130 may be provided with at least one of anti-reflective film layer, wear-resistant layer, or hydrophobic and oleophobic (Anti-fingerprint) layer. In this way, when an anti-reflective film layer is disposed on the light-transmitting surface of the transparent substrate 112 or the filling layer 130, the transmittance of the light beam can be improved, thereby increasing the effective utilization rate of the light beam. In addition, in an optional embodiment of the present disclosure, a wear-resistant layer can also be provided on the light-emitting surface of the transparent substrate 112 or the filling layer 130 to ensure the stability of the optical element 100 during assembly or operation, and to reduce the chance that light propagation is affected by surface wear. Similarly, a hydrophobic and oleophobic layer can also be provided according to actual needs, so as to improve the anti-fingerprint ability and ensure that the light-transmitting surface of the transparent substrate 112 or the filling layer 130 remains clean and bright.

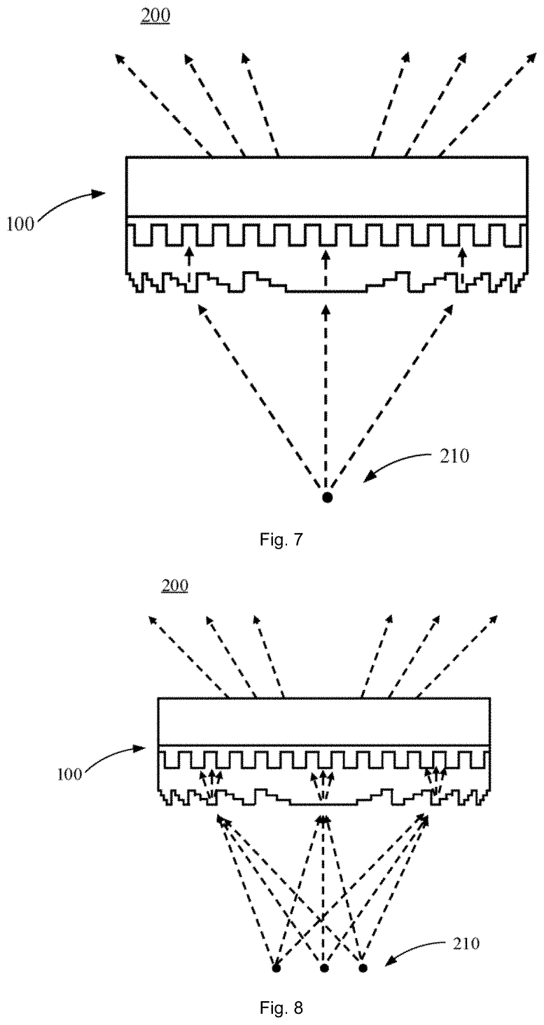

As shown in FIG. 7 and FIG. 8, the embodiment of the present disclosure also provides an optical module 200, which may include the optical element 100 in the foregoing embodiments and the light source 210, wherein the light source 210 is located at the focal plane of the Fresnel lens 120 of the optical element 100, and the collimating portion of the Fresnel lens 120 faces towards the light source 210.

Specifically, the light source 210 in the optical module 200 can be a vertical cavity surface emitting laser or a laser diode (LD), wherein the vertical cavity surface emitting laser has the advantages of small size, circular output light spot, single longitudinal mode output, small threshold current, and low price, and it is easy to integrate into a large-area array which is conducive to the diversity emission modes of the light beams. Arranging the light source 210 at the focal plane of the Fresnel lens 120 is beneficial to collimate and calibrate the light beam better, so as to ensure the quality of the formed preset pattern.

The optical module 200 of the present disclosure is of a simple structure, only includes the light source 210 and the optical element 100. It does not need to add other collimating lenses, and has lower assembly cost compared with the traditional optical module 200. Moreover, the optical element 100 may combine functions of collimation and diffraction, and the overall size can be controlled within 1 mm, which is beneficial to the miniaturization of the optical module 200.

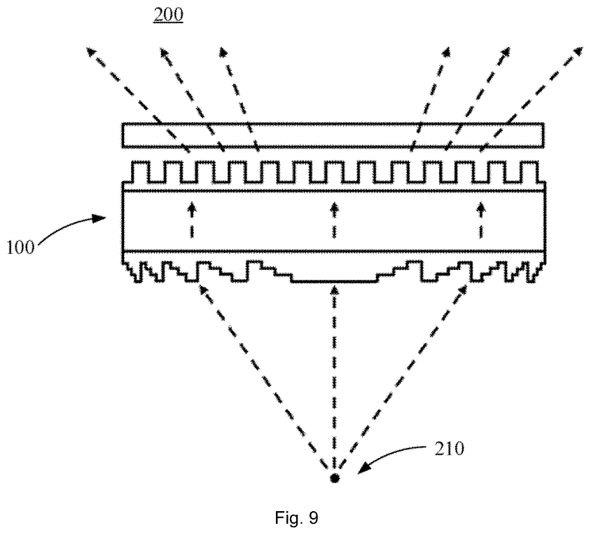

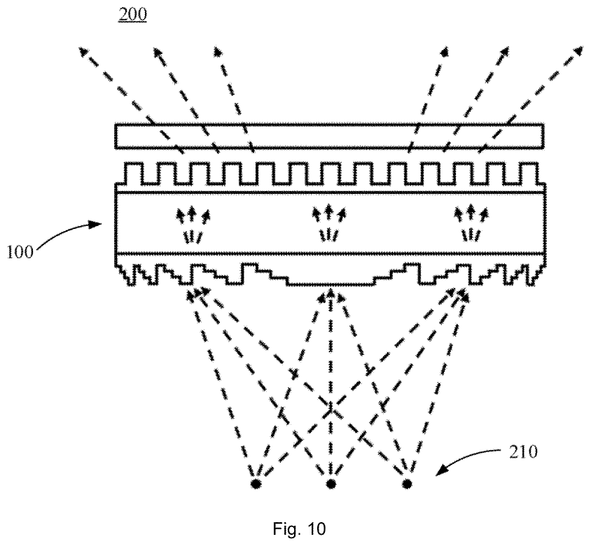

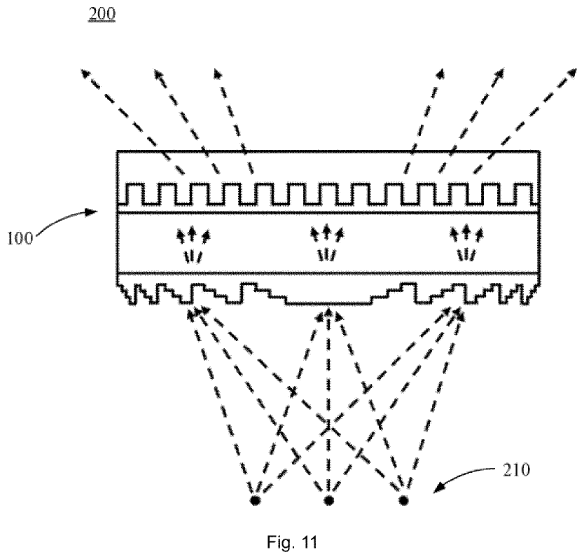

What is shown in FIG. 6, FIG. 9 and FIG. 10 is the structural schematic diagram of the Fresnel lens 120 in the stepped type with the laser diode or the surface emitting laser used respectively, wherein the structure is that the Fresnel lens 120 and the diffractive optical element 110 are respectively arranged on both sides of the transparent substrate. In this state, in order to effectively protect the diffractive optical element 110, a cover plate 140 may be provided on the diffractive optical element 110 to make the structured optical module 200 more stable during operating. A filling layer 130 (as shown in FIG. 11) may also be provided on the diffractive optical element 110 to achieve the same function as the cover plate 140.

As shown in FIG. 1, FIG. 7 and FIG. 8, the structure is that the Fresnel lens 120 and the diffractive optical element 110 are arranged on the same side of the transparent substrate. No matter what form is used, by arranging the Fresnel lens 120 and the diffractive optical element 110 as a whole, the occupied space is effectively reduced, which can improve the alignment accuracy of the module and reduce the assembly cost while ensuring high efficiency and low processing difficulty, and it is beneficial to the miniaturization of the optical module 200.

The above descriptions are only some preferred embodiments of the present disclosure, and are not intended to limit the present disclosure. For those of ordinary skilled in the art, there may be various modifications and changes in the present disclosure. Any modifications, equivalent replacements, improvements made within the spirit and principles of the present disclosure shall be included within the protection scope of the present disclosure.

### INDUSTRIAL APPLICABILITY

The present disclosure provides an optical element and an optical module, the optical element includes a diffractive optical element, and a Fresnel lens connected to the diffractive optical element, so that the light beam passing through the diffractive optical element through the Fresnel lens forms a preset pattern. The assembly cost can be reduced, and it is beneficial to the miniaturization of the optical module.

In addition, it can be understood that the optical elements and optical modules of the present disclosure are reproducible and can be used in various industrial applications. For example, the optical element and optical module of the present disclosure can be used in the field of optical technology.

1. An optical element, wherein the optical element comprises a diffractive optical element, and a Fresnel lens connected to the diffractive optical element, such that a light beam passing through the diffractive optical element through the Fresnel lens forms a preset pattern.

2. The optical element according to claim 1, wherein the diffractive optical element comprises a transparent substrate, and a diffractive layer disposed on the transparent substrate.

3. The optical element according to claim 2, wherein the transparent substrate is made of glass or resin, and the diffractive layer is patterned by micro-nano etching or imprinting process.

4. The optical element according to claim 2, wherein the diffractive layer is filled with a filling layer for covering the diffractive layer, or a cover plate is arranged on the diffractive layer.

5. The optical element according to claim 4, wherein the Fresnel lens is disposed on the transparent substrate, or the Fresnel lens is disposed on the filling layer.

6. The optical element according to claim 4, wherein a difference value between a refractive index n₁ of the diffractive optical element and a refractive index n₂ of the filling layer is: |n₁−n₂|≥0.2.

7. The optical element according to claim 6, wherein a material forming the diffractive optical element has a higher refractive index than a material forming the filled layer, or a material forming the diffractive optical element has a lower refractive index than a material forming the filled layer.

8. The optical element according to claim 2, wherein a transparent conductive layer is provided on one side of the transparent substrate.

9. The optical element according to claim 8, wherein the transparent conductive layer is made of transparent metal oxide or metal doped oxide.

10. The optical element according to claim 2, wherein the Fresnel lens comprises a substrate, and a collimating layer arranged on the substrate, such that light beams passing through the Fresnel lens are emitted in parallel, wherein the collimating layer is located on a side of the substrate facing away from the transparent substrate.

11. The optical element according to claim 10, wherein structure types of the diffractive layer and the collimating layer are any one of a stepped type or a continuous type, respectively.

12. The optical element according to claim 4, wherein the transparent substrate or a light-transmitting surface of the filling layer is provided with at least one of an anti-reflective film layer, a wear-resistant layer, and a hydrophobic and oleophobic layer.

13. An optical module, wherein the optical module comprises the optical element according to claim 1 and a light source, wherein the light source is located at a focal plane of the Fresnel lens of the optical element, and a collimating portion of the Fresnel lens faces towards the light source.

14. The optical module according to claim 13, wherein the light source in the optical module is a vertical cavity surface emitting laser or a laser diode.

15. The optical element according to claim 3, wherein the diffractive layer is filled with a filling layer for covering the diffractive layer, or a cover plate is arranged on the diffractive layer.

16. The optical element according to claim 5, wherein a difference value between a refractive index n₁ of the diffractive optical element and a refractive index n₂ of the filling layer is: |n₁−n₂|≥0.2.

17. The optical element according to claim 3, wherein a transparent conductive layer is provided on one side of the transparent substrate.

18. The optical element according to claim 4, wherein a transparent conductive layer is provided on one side of the transparent substrate.

19. The optical element according to claim 3, wherein the Fresnel lens comprises a substrate, and a collimating layer arranged on the substrate, such that light beams passing through the Fresnel lens are emitted in parallel, wherein the collimating layer is located on a side of the substrate facing away from the transparent substrate.

20. The optical element according to claim 5, wherein the transparent substrate or a light-transmitting surface of the filling layer is provided with at least one of an anti-reflective film layer, a wear-resistant layer, and a hydrophobic and oleophobic layer.
